(19) United States
(12) Patent Application Publication
(10) Pub. No.: US 2018/0048195 A1
(43) Pub. Date: Feb. 15, 2018

(54) ELECTRIC MOTOR

(71) Applicants: CHIN-HSING FENG, Taoyuan County (TW); JII-CHYUN WANG, Taoyuan County (TW)

(72) Inventors: CHIN-HSING FENG, Taoyuan County (TW); JII-CHYUN WANG, Taoyuan County (TW)

(21) Appl. No.: 15/233,112

(22) Filed: Aug. 10, 2016

(51) Int. Cl. H02K 1/27; H02K 1/12; H02K 7/08

(52) U.S. Cl. CPC H02K 1/27; H02K 7/083; H02K 1/12

(57) ABSTRACT

An electric motor includes a permanent magnet rotor unit and a stator unit. The permanent magnet rotor unit includes a spindle, at least one magnet fixedly disposed beside the spindle, at least one magnetic yoke fixedly disposed at an outer end of the magnet. The stator unit includes a cylindrical extension body. At least one coil is provided on the extension body. The extension body with the coil is mounted to the space between the magnet and the magnetic yoke. The electric motor doesn't use silicon steel plate, so it is light in weight. When the electric current is outputted, it doesn't need rectification. The magnetic field lines won't be diffused and interfere with each other to enhance the magnetic flux effectively.

### BACKGROUND OF THE INVENTION

### 1. Field of the Invention

The present invention relates to an electric motor, and more particularly to a micro power generating structure. The electric motor is light in weight. When the electric current is outputted, it doesn't need rectification. The magnetic flux is enhanced effectively.

### 2. Description of the Prior Art

A conventional power generator 1, as shown in FIG. 1, FIG. 2 and FIG. 10, includes a permanent magnet rotor 11. The permanent magnet rotator 11 is composed of a North pole 111 and a South pole 112. Two corresponding sides of the permanent magnet rotor 11 are provided coils 12. A magnetic yoke 13 is provided to wrap the exteriors of the coils 12. When running, the permanent magnet rotator 11 is rotated, enabling the magnetic field lines from the North pole 111 and the South pole 112 to pass through the coils 12. As shown in FIG. 1, when the permanent magnet rotator 11 is turned 0 or 360 degrees, the power generator generates forward current. As shown in FIG. 2, when the permanent magnet rotator 11 is turned 180 degrees, the power generator generates reverse current. When the permanent magnet rotator 11 is turned 90 or 270 degrees, there is no electric current generation because the magnetic field lines don't pass through the coils 12. The conventional power generator uses silicone steel sheets, so it is heavy in weight and large in size. The electric current includes forward current and reverse current. When the electric current is outputted, it must be rectified by a rectifier to output direct current. Besides, only one magnetic yoke is used to wrap the whole exterior of the power generator, the magnetic field lines are diffused. Specially, the magnetic field strides the central spindle 10. When running, the magnetic field lines are diffused easily, which lowers the magnetic flux. The efficiency is also lowered accordingly. The number of the magnetic poles of the conventional power generating structure must be even for running.

Accordingly, the inventor of the present invention has devoted himself based on his many years of practical experiences to solve these problems.

### SUMMARY OF THE INVENTION

The primary object of the present invention is to provide an electric motor to improve the shortcomings of the prior art. The electric motor doesn't use silicon steel plates, so it is light in weight.

Another object of the present invention is to provide an electric motor which directly generates forward current all the time because the directions of the magnetic field lines are the same, from the outside toward the central spindle, and the magnetic field lines don't pass through the spindle. When the electric current is outputted, it doesn't need rectification.

A further object of the present invention is to provide an electric motor which generates independent magnetic fields, so the magnetic flux per unit area is two times as much as the prior art according to the inventor's experiment. Compared to the prior art, the magnetic field lines generated by the present invention won't be diffused around and interfere with each other.

In order to achieve the aforesaid object, the electric motor of the present invention may include a main body. The main body includes a permanent magnet rotor unit and a stator unit. The electric motor may further include two bearings, two bearing seats, and a casing.

Preferably, the permanent magnet rotor unit includes a spindle at a central portion thereof. A portion of the spindle is fixedly connected with a connecting member. At least one side of the connecting member is fixedly connected with a magnet. An outer side of the magnet is connected with a magnetic yoke. The cross-section of the magnetic yoke is in a U-like shape. A space is defined between the magnet and the magnetic yoke.

Preferably, the stator unit includes a plate body. The plate body has a central opening. The opening is adapted for insertion of the spindle. The plate body is provided with a cylindrical extension body. The inside of the extension body is a hollow compartment. At least one coil is embedded on the extension body. The plate body is provided with at least one protruding block. The extension body with the coil is mounted to the space between the magnet and the magnetic yoke.

Preferably, the two bearings are fitted on two ends of the spindle.

Preferably, the central portions of the two bearing seats are configured to receive the two bearings. The two bearing seats are disposed at the exterior of the permanent magnet rotor unit and the stator unit.

Preferably, the casing is hollow and has two open ends to accommodate the permanent magnet rotor unit and the stator unit therein. An inner wall of the casing is formed with at least one groove. The groove is adapted for engagement of the protruding block of the stator unit. The two bearing seats are locked with screws to seal the casing.

Preferably, the magnet has an outer curved surface. The magnetic yoke located at the outer end of the magnet also has an arc shape corresponding to the magnet.

### BRIEF DESCRIPTION OF THE DRAWINGS

FIG. 1 is a schematic view of a conventional power generator;

FIG. 2 is another schematic view of the conventional power generator;

FIG. 3 is a perspective view of the present invention;

FIG. 4 is an exploded view of the present invention;

FIG. 5 is a side sectional view of the present invention;

FIG. 6 is a top sectional view of the present invention;

FIG. 7 is a schematic view showing rotation of the permanent magnet rotor unit of the present invention;

FIG. 8 is another schematic view showing rotation of the permanent magnet rotor unit of the present invention;

FIG. 9 is a further schematic view showing rotation of the permanent magnet rotor unit of the present invention;

FIG. 10 is a schematic view showing the magnetic field of the conventional power generator; and

FIG. 11 is a schematic view showing the magnetic field of the present invention.

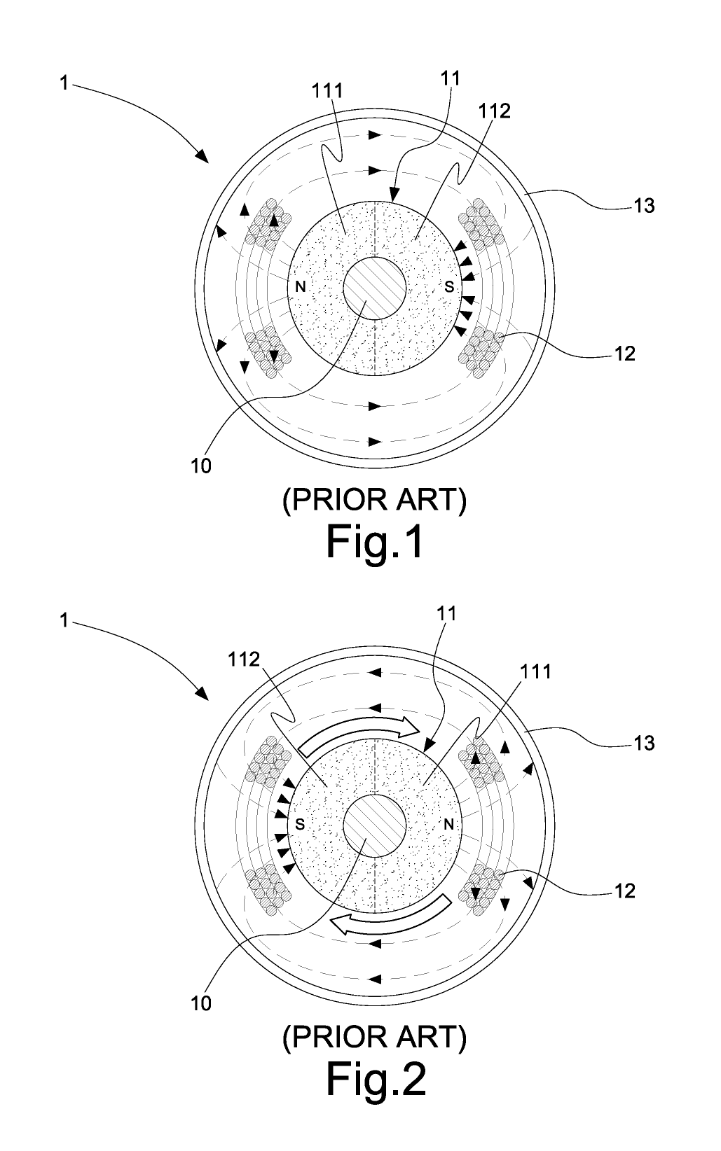

### DETAILED DESCRIPTION OF THE PREFERRED EMBODIMENTS

Embodiments of the present invention will now be described, by way of example only, with reference to the accompanying drawings.

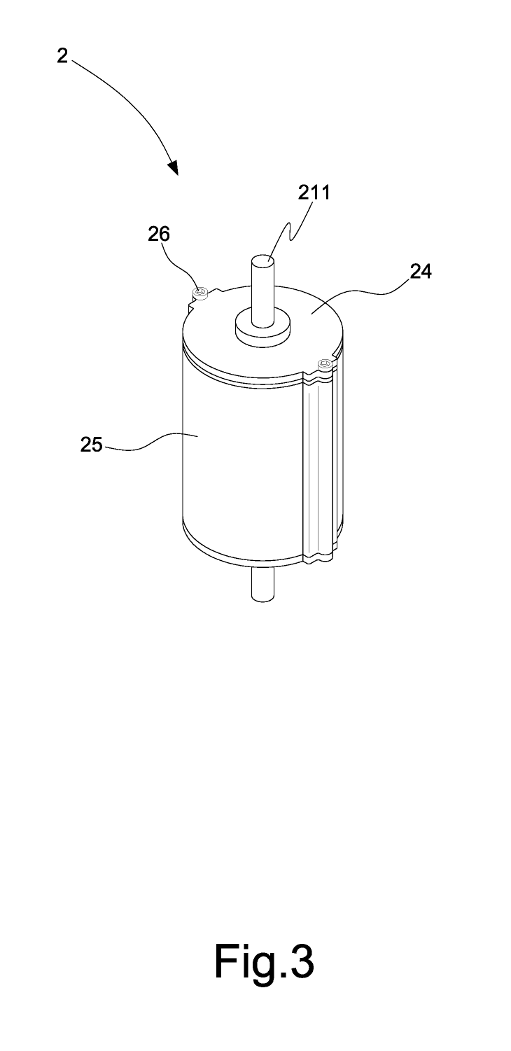

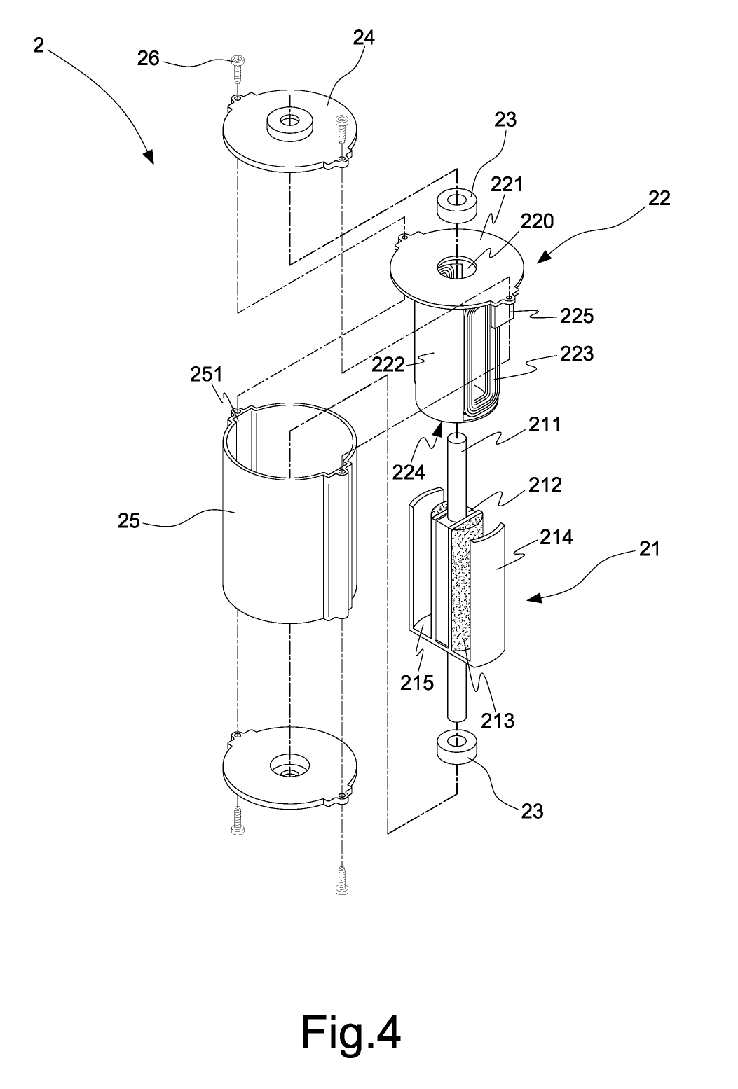

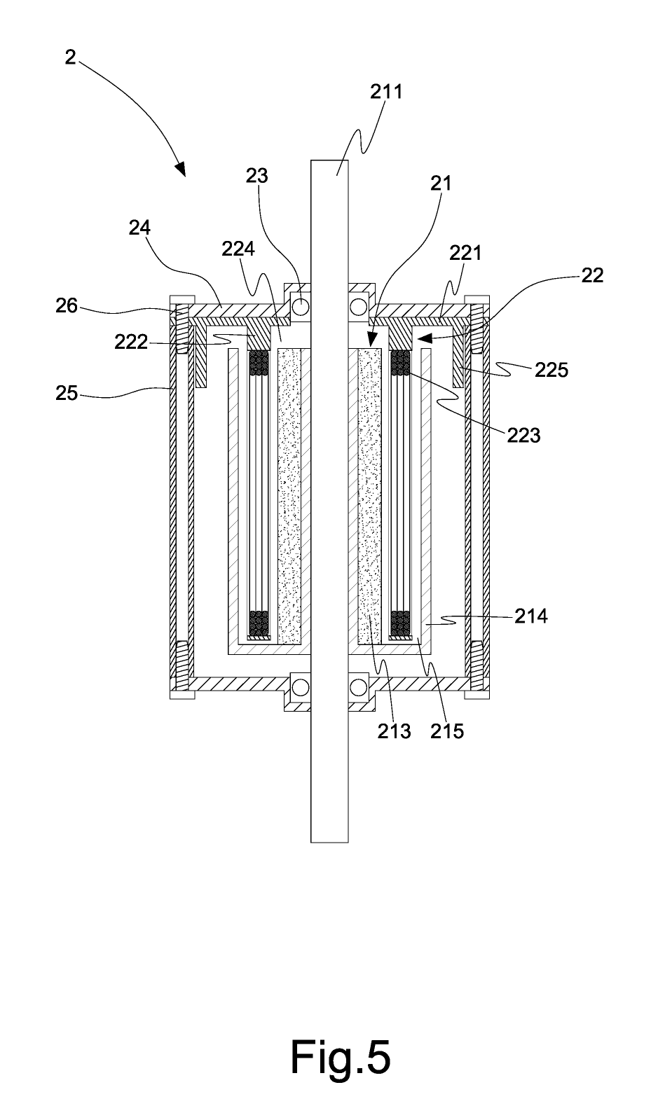

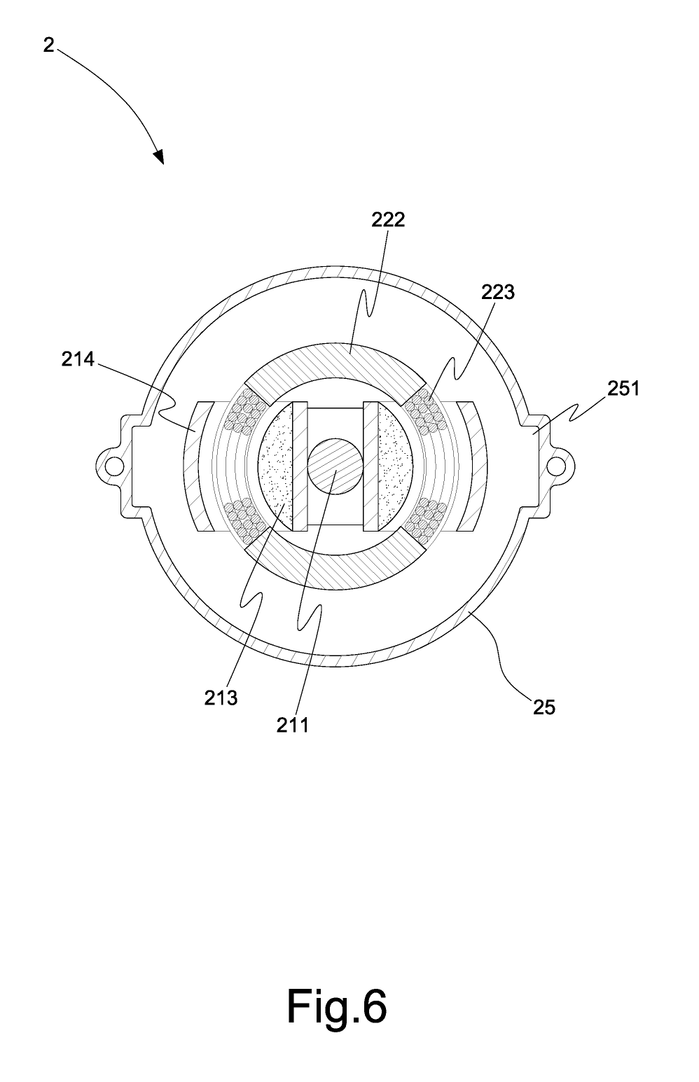

Referring to FIG. 3, FIG. 4, FIG. 5 and FIG. 6, the present invention discloses an electric motor which is light in weight and doesn't need rectification. The electric motor includes a main body 2. The main body 2 includes a permanent magnet rotor unit 21 and a stator unit 22. The electric motor further includes two bearings 23, two bearing seats 24, and a casing 25. The permanent magnet rotor unit 21 includes a spindle 211 at a central portion thereof. A portion of the spindle 211 is fixedly connected with a connecting member 212. At least one side of the connecting member 212 is fixedly connected with a magnet 213. An outer side of the magnet 213 is connected with a magnetic yoke 214. The cross-section of the magnetic yoke 214 is in a U-like shape. A space 215 is defined between the magnet 213 and the magnetic yoke 214. The stator unit 22 includes a plate body 221. The plate body 221 has a central opening 220. The opening 220 is adapted for insertion of the spindle 211. The plate body 221 is provided with a cylindrical extension body 222. The inside of the extension body 222 is a hollow compartment 224. At least one coil 223 is embedded on the extension body 222. The plate body 221 is provided with at least one protruding block 225. The extension body 222 with the coil 223 is mounted to the space 215 between the magnet 213 and the magnetic yoke 214. The two bearings 23 are fitted on two ends of the spindle 211. The central portions of the two bearing seats 24 are configured to receive the two bearings 23. The two bearing seats 24 are disposed at the exterior of the permanent magnet rotor unit 21 and the stator unit 22. The casing 25 is hollow and has two open ends to accommodate the permanent magnet rotor unit 21 and the stator unit 22 therein. An inner wall of the casing 25 is formed with at least one groove 251. The groove 251 is adapted for engagement of the protruding block 225 of the stator unit 22. The two bearing seats 24 are locked with screws 26 to seal the casing 25. The magnet 213 has an outer curved surface. The magnetic yoke 214 located at the outer end of the magnet 213 also has an arc shape corresponding to the magnet 213.

The stator unit 22 of the present invention is fixedly connected with the casing 25 and the bearing seats 24. The permanent magnet rotor unit 21 is rotated relative to the stator unit 22 by means of the bearings 23.

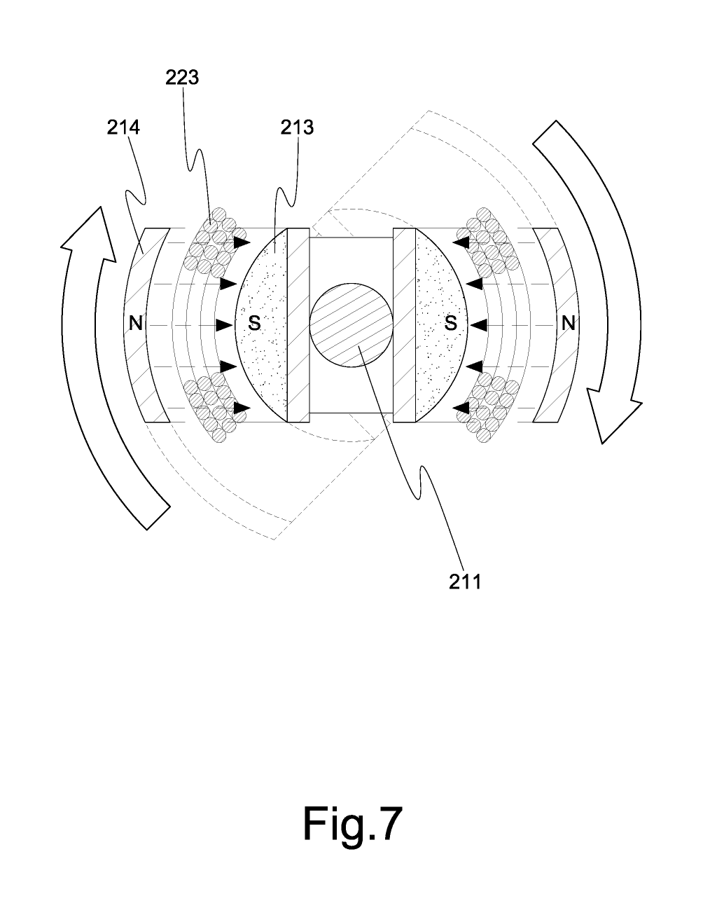

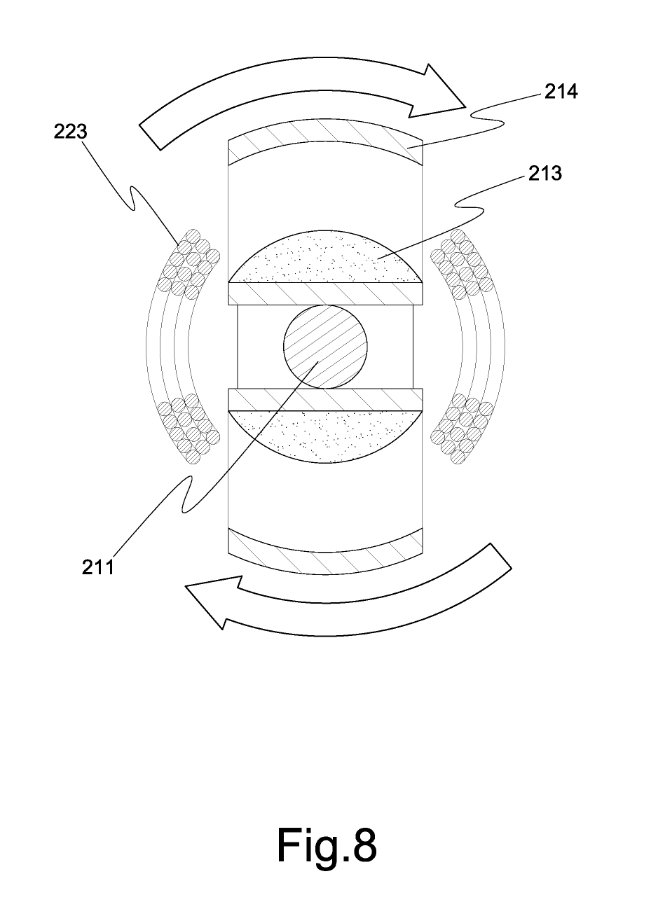

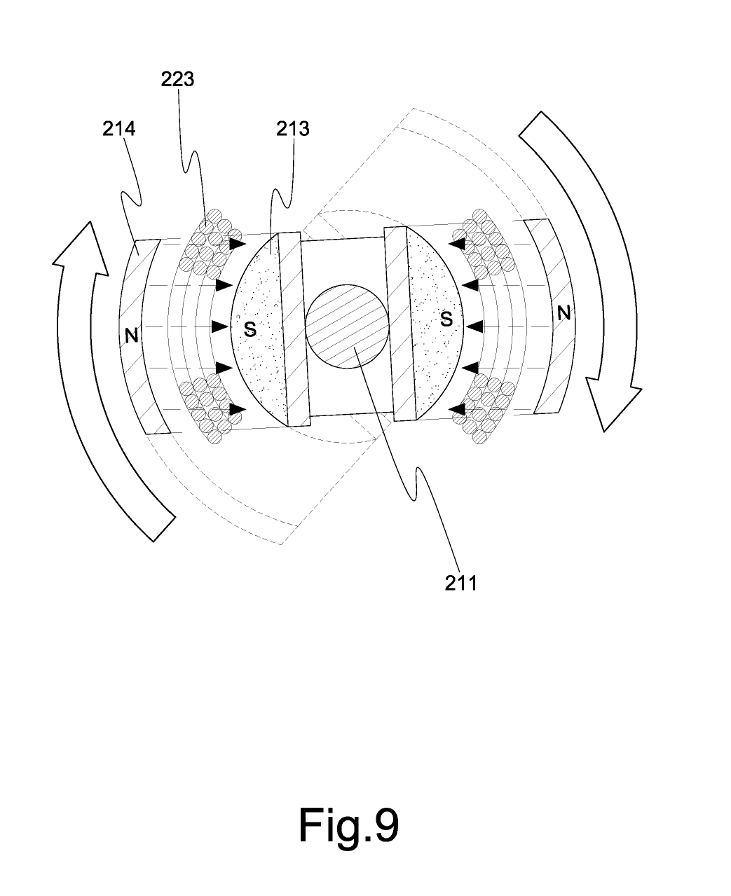

Referring to FIG. 7, when the spindle 211 is rotated by an external force, the permanent magnet rotor unit 21 is rotated relative to the stator unit 22. When the rotation angle is defined as 0 or 360 degrees as shown in the drawing, the magnetic yoke 214, the coil 223, and the magnet 213 form magnetic field lines to pass through the coil 223. The direction of the generated electric current is from the magnetic yoke 214 through the coil 223 toward the central magnet 213. The magnetic field lines at two sides of the spindle 211 don't pass through the central spindle 211. Referring to FIG. 8, when the spindle 211 is rotated to bring the permanent magnet rotor unit 21 to rotate relative to the stator unit 22 and the rotation angle is defined as 90 or 270 degrees as shown in the drawing, because the magnetic field lines don't pass through the coil 223, there is no electric current generation. Referring to FIG. 9, when the spindle 211 is rotated to bring the permanent magnet rotor unit 21 to rotate relative to the stator unit 22 and the rotation angle is defined as 180 degrees as shown in the drawing, the magnetic yoke 214, the coil 223, and the magnet 213 form magnetic field lines to pass through the coil 223. The direction of the generated electric current is from the magnetic yoke 214 through the coil 223 toward the central magnet 213. No matter what angle the permanent magnet rotor unit 21 of the present invention is turned, the direction of the generated electric current is from the magnetic yoke 214 through the coil 223 toward the central magnet 213 all the time. That is to say, all the electric current is forward current, which can be output directly, without rectification. Furthermore, the directions of the magnetic field lines are the same, not passing through the central spindle 211. Each magnetic field is independent, not interfering with each other, so the magnetic field lines won't be diffused and interfere with each other to enhance the magnetic flux effectively.

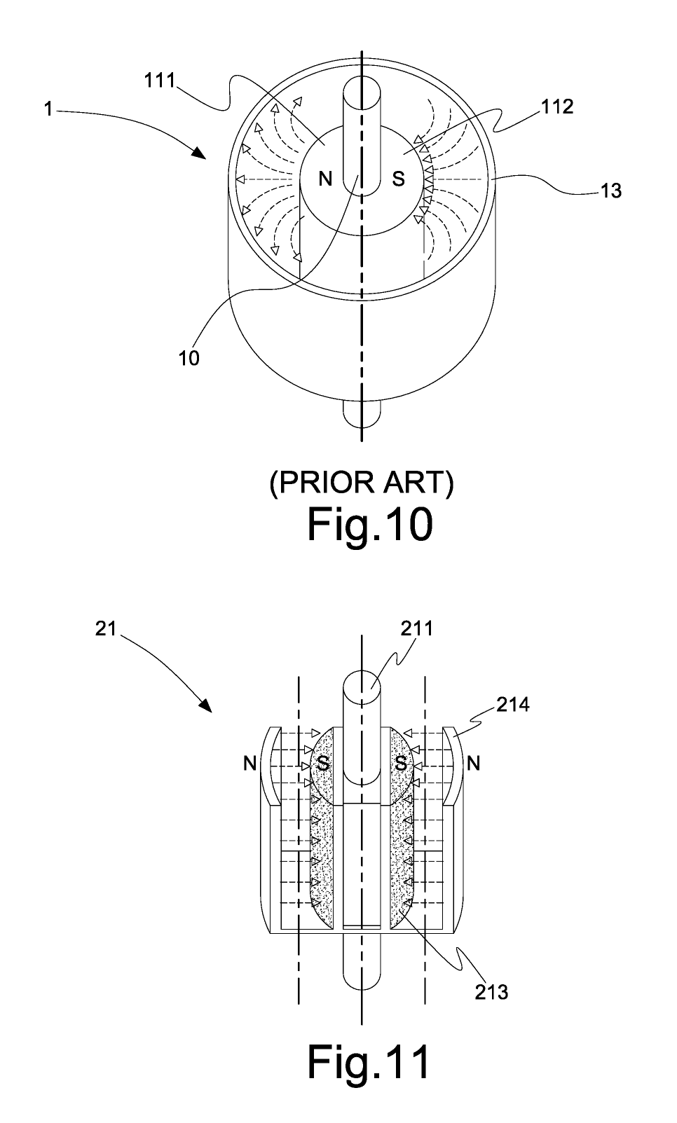

Referring to FIG. 10 and FIG. 11, the difference between the prior art and the present invention can be seen clearly. As shown in FIG. 10, the electric current includes forward current and reverse current. When outputted, the electric current must be rectified by a rectifier to output direct current. In addition, only a magnetic yoke is used to wrap the whole exterior of the power generator. The magnetic field lines are diffused, and the magnetic field goes across the central spindle 10. During running, the magnetic field lines are easily diffused around, so the whole magnetic flux is lowered. The efficiency is also lowered. On the contrary, as shown in FIG. 11, each magnetic field of the present invention is independent and disposed at the periphery of the spindle 211, namely the center of the magnetic field and the spindle are not coaxial. All the magnetic field lines face the spindle 211 in the same direction, without diffusion.

Accordingly, the electric motor of the present invention is light in weight and doesn't need rectification. The weight is decreased, and the size is reduced, and the magnetic flux is increased, and there is no need for rectification when the electric current is outputted. The advantages of the present invention are numerous.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electric motor, comprising:
a permanent magnet rotor unit, the permanent magnet rotor unit comprising a spindle at a central portion thereof, at least one side of the spindle being fixedly connected with a magnet, an outer side of the magnet being connected with a magnetic yoke, a space being defined between the magnet and the magnetic yoke;
a stator unit, the stator unit comprising at least one coil, the coil extending to the space of the permanent magnet rotor unit;
the permanent magnet rotor unit being rotatable relative to the stator unit.

2. The electric motor as claimed in claim 1, wherein a portion of the spindle is fixedly connected with a connecting member, and the magnet is disposed on the connecting member.

3. The electric motor as claimed in claim 1, wherein the magnetic yoke has a U-shaped cross-section.

4. The electric motor as claimed in claim 1, wherein the stator unit comprises a plate body, the plate body has a central opening, the opening is adapted for insertion of the spindle, the plate body is provided with a cylindrical extension body, an inside of the extension body is a hollow compartment, and the coil is disposed on the extension body.

5. The electric motor as claimed in claim 1, further comprising two bearings, two bearing seats and a hollow casing, the two bearings being disposed at two ends of the spindle and received in the two bearing seats, the two bearing seats being disposed at two ends of the casing, the casing being configured to accommodate the permanent magnet rotor unit and the stator unit therein.

6. The electric motor as claimed in claim 5, wherein an inner wall of the casing is formed with at least one groove, the plate body of the stator unit is provided with at least one protruding block, and the groove is adapted for engagement of the protruding block.

7. The electric motor as claimed in claim 1, wherein the magnet has an outer curved surface, and the magnetic yoke located at the outer end of the magnet has an arc shape corresponding to the magnet.
